(19) United States
(12) Patent Application Publication
(10) Pub. No.: US 2006/0208981 A1
(43) Pub. Date: Sep. 21, 2006

(54) Liquid crystal display and driving method thereof

(76) Inventors: Soo-Guy Rho, Kyungki-do (KR); Chong-Chul Chai, Seoul (KR); Keun-Kyu Song, Kyungki-do (KR); Jeong-Ye Choi, Kyungki-do (KR); Nam-Seok Roh, Kyungki-do (KR)

Correspondence Address: CANTOR COLBURN, LLP, 55 GRIFFIN ROAD SOUTH, BLOOMFIELD, CT, 06002, US

(21) Appl. No.: 10/525,823

(22) PCT Filed: Aug. 29, 2003
(86) PCT No.: PCT/KR03/01762

§ 371 Date: Oct. 4, 2005

(51) Int. Cl. G09G 3/36

(52) U.S. Cl. 345/88

(57) ABSTRACT

A liquid crystal display is provided, which includes: an array of a plurality of alternately arranged first and second rows of pixels, each first row including red, blue and green pixels or red, green and blue pixel arranged in sequence and each second row including red, blue and green pixels or red, green and blue pixel arranged in sequence and having an arrangement shifted by one pixel from the first row, each pixel including a pixel electrode and a thin film transistor, a plurality of gate lines extending in a row direction for transmitting a gate signal to the pixels; and a plurality of data lines extending in a column direction for transmitting data signals to the pixels.

### BACKGROUND OF THE INVENTION

(a) Field of the Invention

The present invention relates to a liquid crystal display and driving method thereof.

(b) Description of Related Art

Generally, a liquid crystal display (LCD) includes a liquid crystal panel assembly including two panels provided with two kinds of field generating electrodes such as pixel electrodes and a common electrode and a liquid crystal layer with dielectric anisotropy interposed therebetween. The variation of the voltage difference between the field generating electrodes, i.e., the variation in the strength of an electric field generated by the electrodes changes the transmittance of the light passing through the LCD, and thus desired images are obtained by controlling the voltage difference between the electrodes.

The LCD includes a plurality of pixels with pixel electrodes and red (R), green (G) and blue (B) color filters. The pixels are driven to perform display operation by way of the signals applied thereto through display signal lines. The signal lines include gate lines (or scanning signal lines) for carrying the scanning signals, and data lines for carrying data signals. Each pixel has a thin film transistor (TFT) connected to one of the gate lines and one of the data lines to control the data signals applied to the pixel electrode.

Meanwhile, there are several types of arrangement of the red (R), green (G) and blue (B) color filters. Examples are a stripe type where the color filters of the same color are arranged in the same pixel columns, a mosaic type where the red, green and blue color filters are arranged in turn along the row and column directions, and a delta type where the pixels are arranged zigzag in the column direction and the red, green and blue color filters are arranged in turn. The delta type correctly represents a circle or a diagonal line.

The ClairVoyante Laboratories has proposed a pixel arrangement called the “PenTile Matrix™,” which is advantageous in displaying high resolution images while gives minimized design cost. In such a pixel arrangement, the unit pixel of blue is common to two dots, and the neighboring blue pixels receive the data signals from one data driving IC while being driven by two different gate driving ICs. With the use of the PenTile Matrix pixel structure, the resolution of the ultra extended graphics array (UXGA) level can be realized by way of a display device of the super video graphics array (SVGA) level. Furthermore, the number of low-cost gate driving ICs is increased, but the number of high-cost data driving ICs is decreased. This minimizes the production cost for the display device.

The LCD having the pixel arrangements is required to be rendered for increasing resolution, and a pixel group for the rendering is required to be properly selected for preventing deterioration of visibility.

### SUMMARY OF THE INVENTION

A motivation of the present invention is to provide a liquid crystal display having excellent visibility.

A liquid crystal display is provided, which includes: an array of a plurality of alternately arranged first and second rows of pixels, each first row including red, blue and green pixels or red, green and blue pixel arranged in sequence and each second row including red, blue and green pixels or red, green and blue pixel arranged in sequence and having an arrangement shifted by one pixel from the first row, each pixel including a pixel electrode and a thin film transistor; a plurality of gate lines extending in a row direction for transmitting a gate signal to the pixels; and a plurality of data lines extending in a column direction for transmitting data signals to the pixels.

The liquid crystal display is preferably rendered preferably based on a pixel group for rendering including a center pixel and a plurality of peripheral pixels having weights depending on a distance from the center pixel. Preferably, the weight becomes large as the distance from the center pixel increases.

Each data line may include a connection portion for receiving data signals from an external device.

The liquid crystal display may further include a passivation layer interposed between the pixel electrodes and the gate lines and the data lines, made of low dielectric material, and having a plurality of contact holes for connecting the thin film transistors and the pixel electrodes.

A method of driving a liquid crystal display including a plurality of pixels including a plurality of switching elements, a plurality of signal lines connected to the switching elements is provided, which includes: weighting the pixels for rendering based on a pixel group including a center pixel and a plurality of peripheral pixels such that weight for the pixels depends on a distance from the center pixel; providing data voltages to the data lines, the data voltages having values depending on the weight; and turning on the switching elements to transmit the data voltages to the pixel electrodes.

The weight preferably becomes large as the distance from the center pixel increases.

### BRIEF DESCRIPTION OF THE DRAWINGS

The above and other advantages of the present invention will become more apparent by describing preferred embodiments thereof in detail with reference to the accompanying drawings in which:

FIG. 1 is a block diagram of an LCD according to an embodiment of the present invention;

FIG. 2 is an equivalent circuit diagram of a pixel of an LCD according to an embodiment of the present invention;

FIGS. 3A, 4A and 5A illustrate spatial arrangements of pixels of LCDs according to embodiments of the present invention;

FIGS. 3B, 4B and 5B illustrates a group of pixels forming a dot, which is an elementary unit for an image in the pixel arrangements shown in FIGS. 4A and 5A, respectively;

FIG. 6 is a layout view of an exemplary TFT array panel for an LCD according to an embodiment of the present invention;

FIG. 7 is a sectional view of the TFT array panel shown in FIG. 6 taken along the line VII-VII′;

FIG. 8 is a layout view of an exemplary TFT array panel for an LCD according to another embodiment of the present invention;

FIGS. 9A and 9B are sectional views of the TFT array panel shown in FIG. 8 taken along the line IXA-IXA′ and the line IXB-IXB′, respectively;

FIGS. 10A-10C are exemplary pixel groups for rendered LCDs according to embodiments of the present invention;

FIG. 11 illustrates an exemplary weighting in rendering of an LCD according to an embodiment of the present invention; and

FIGS. 12A and 12B exemplary weighting in rendering of an LCD shown in FIGS. 10B and 10C, respectively.

### DETAILED DESCRIPTION OF PREFERRED EMBODIMENTS

The present invention now will be described more fully hereinafter with reference to the accompanying drawings, in which preferred embodiments of the inventions are shown.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present In contrast, when an element is referred to as being “directly on” another element, there are no intervening elements present.

Now, LCDs according to embodiments of this invention will be described in detail with reference to the accompanying drawings.

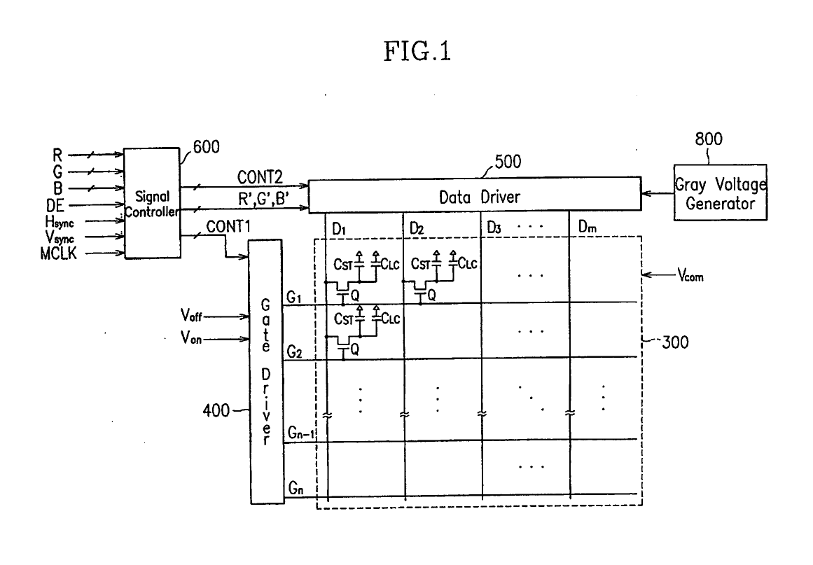

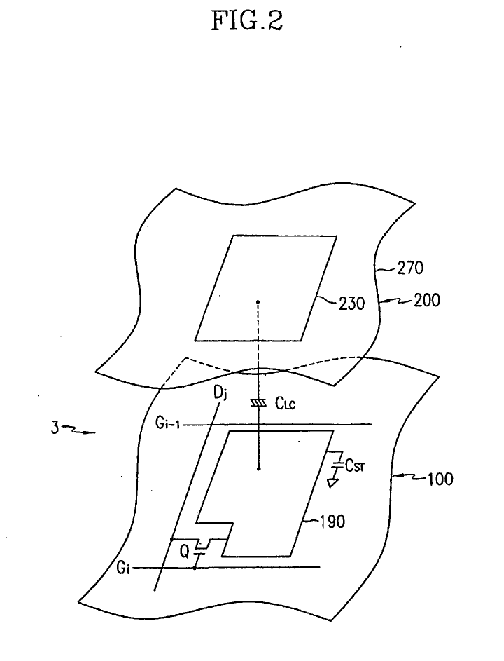

FIG. 1 is a block diagram of an LCD according to an embodiment of the present invention, and FIG. 2 is an equivalent circuit diagram of a pixel of an LCD according to an embodiment of the present invention.

Referring to FIG. 1, an LCD according to an embodiment of the present invention includes a LC panel assembly 300, a gate driver 400 and a data driver 500 which are connected to the panel assembly 300, a gray voltage generator 800 connected to the data driver 500, and a signal controller 600 controlling the above elements.

The LC panel assembly 300, in structural view shown in FIG. 2, includes a lower panel 100, an upper panel 200 and a liquid crystal layer 3 interposed therebetween while it includes a plurality of display signal lines G₁-Gₙ and D₁-Dₘ and a plurality of pixels connected thereto and arranged substantially in a matrix in circuital view shown in FIGS. 1 and 2.

The display signal lines G₁-Gₙ and D₁-Dₘ are provided on the lower panel 100 and include a plurality of gate lines G₁-Gₙ transmitting gate signals (called scanning signals) and a plurality of data lines D₁-Dₘ transmitting data signals. The gate lines G₁-Gₘ extend substantially in a row direction and are substantially parallel to each other, while the data lines D₁-Dₘ extend substantially in a column direction and are substantially parallel to each other.

Each pixel includes a switching element Q connected to the display signal lines G₁-Gₙ and D₁-Dₘ, and an LC capacitor C_{LC} and a storage capacitor C_{ST} that are connected to the switching element Q. The storage capacitor C_{ST} may be omitted if unnecessary.

The switching element Q such as a TFT is provided on the lower panel 100 and has three terminals: a control terminal connected to one of the gate lines G₁-Gₙ; an input terminal connected to one of the data lines D₁-Dₘ; and an output terminal connected to the LC capacitor C_{LC} and the storage capacitor CST.

The LC capacitor C_{LC} includes a pixel electrode 190 on the lower panel 100, a common electrode 270 on the upper panel 200, and the LC layer 3 as a dielectric between the electrodes 190 and 270. The pixel electrode 190 is connected to the switching element Q, and the common electrode 270 covers the entire surface of the upper panel 100 and is supplied with a common voltage. Vcom. Alternatively, both the pixel electrode 190 and the common electrode 270, which have shapes of bars or stripes, are provided on the lower panel 100.

The storage capacitor C_{ST} is an auxiliary capacitor for the LC capacitor C_{LC}. The storage capacitor C_{ST} includes the pixel electrode 190 and a separate signal line (not shown), which is provided on the lower panel 100, overlaps the pixel electrode 190 via an insulator, and is supplied with a predetermined voltage such as the common voltage Vcom. Alternatively, the storage capacitor C_{ST} includes the pixel electrode 190 and an adjacent gate line called a previous gate line, which overlaps the pixel electrode 190 via an insulator.

For color display, each pixel represents its own color by providing one of a plurality of color filters 230 in an area occupied by the pixel electrode 190. The color filter 230 shown in FIG. 2 is provided in the corresponding area of the upper panel 200. Alternatively, the color filter 230 is provided on or under the pixel electrode 190 on the lower panel 100.

Preferably, the color of the color filter 230 is one of the primary colors such as red, green and blue. Hereinafter, a pixel is referred to as red, greed or blue pixel based on the color represented by the pixel and indicated by reference numerals R, G or B.

A pair of polarizers (not shown) polarizing the light from the lamps 341 are attached on the outer surfaces of the panels 100 and 200 of the panel assembly 300.

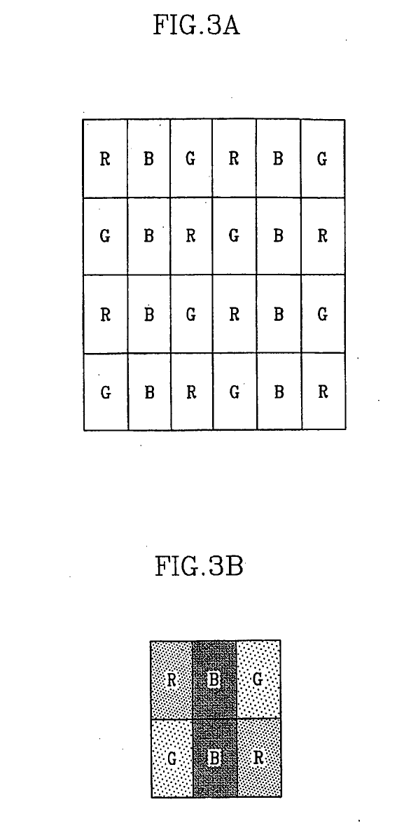

FIG. 3A illustrates a spatial arrangement of pixels of an LCD according to an embodiment of the present invention.

Referring to FIG. 3A, a plurality of pixels having substantially equal size are arranged in a matrix including a plurality of pixel row and a plurality of pixel columns.

Each pixel row includes pixels representing three colors, i.e., red pixels R, green pixels G, and blue pixels B. The sequence of the pixels in a pixel row shown in FIG. 3A is the red pixel R, the blue pixel B, and the green pixel G or the green pixel G, the blue pixel B, and the red pixel R.

The pixel columns include a plurality of bicolor columns and a plurality of unicolor columns. As shown in FIG. 3A, each bicolor column includes red pixels R and green pixels G and each unicolor column includes blue pixels B.

When viewing only bicolor columns, any two pixels adjacent to each other in a row direction or a column direction represent different colors and thus the bicolor columns form a checkerboard pattern. Each unicolor column is interposed between the bicolor columns.

FIG. 3B illustrates a group of pixels forming a dot, which is an elementary unit for an image in the pixel arrangements shown in FIG. 3A. Each group includes six pixels, i.e., two adjacent center pixels in a unicolor column and four pixels in bicolor columns, which are adjacent to the respective center pixels in the row direction.

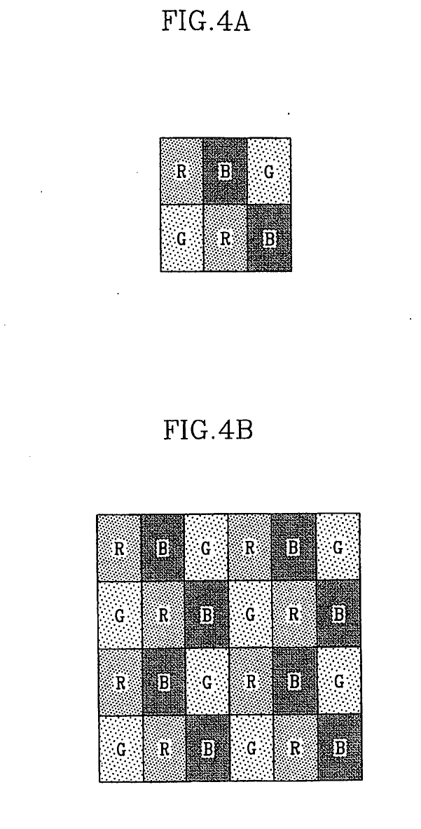

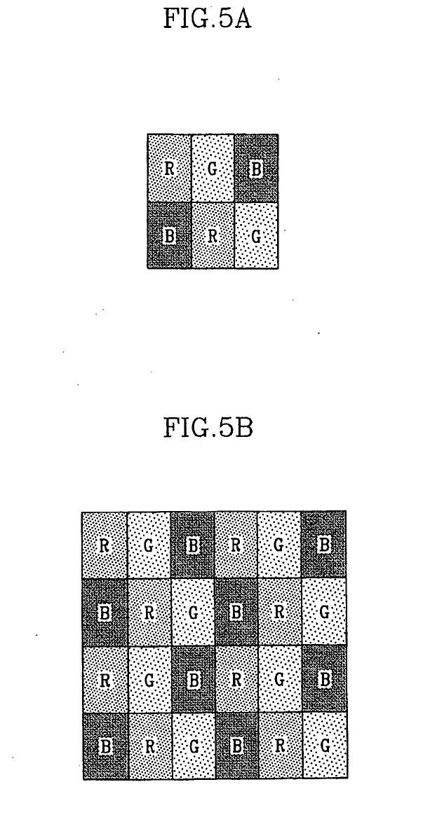

FIGS. 4A and 5A illustrate spatial arrangements of pixels of LCDs according to other embodiments of the present invention.

Referring to FIGS. 4A and 5A, a plurality of pixels having substantially equal size are arranged in a matrix including a plurality of pixel row and a plurality of pixel columns.

Each pixel row includes pixels representing three colors, i.e., red pixels R, green pixels G, and blue pixels B. The sequence of the pixels in a pixel row shown in FIG. 4A is the red pixel R, the blue pixel B, and the green pixel G while that shown in FIG. 5A is the red pixel R, the green pixel G, and the blue pixel B. The pixels in adjacent two pixel row representing the same color are arranged in adjacent columns, and respective pixel arrangements in odd columns and even columns are equal. Each column includes two of red pixels R, green pixels G, and blue pixels B.

FIGS. 4B and 5B illustrates a group of pixels forming a dot, which is an elementary unit for an image in the pixel arrangements shown in FIGS. 4A and 5A, respectively. Each group includes a 2×3 pixel matrix. The matrix shown in FIG. 4B includes a first row including a red pixel R, a blue pixel B, and a green pixel G arranged in sequence and a second row including a green pixel G, a red pixel R, and a blue pixel B arranged in sequence. On the contrary, the matrix shown in FIG. 5B includes a first row including a red pixel R, a green pixel G, and a blue pixel B arranged in sequence and a second row including a blue pixel B, a red pixel R, and a green pixel G arranged in sequence.

The pixel arrangements shown in FIGS. 4A and 5A give visibility superior to that shown in FIG. 3A. In detail, the pixel arrangement shown in FIG. 3A causes the blue pixel column to be seen as a blue bar, while those shown in FIGS. 4A and 5B do not.

The dots shown in FIGS. 4B and 5B are merely examples thereof, and dots for the pixel arrangements shown in FIGS. 4A and 5B may have various configurations.

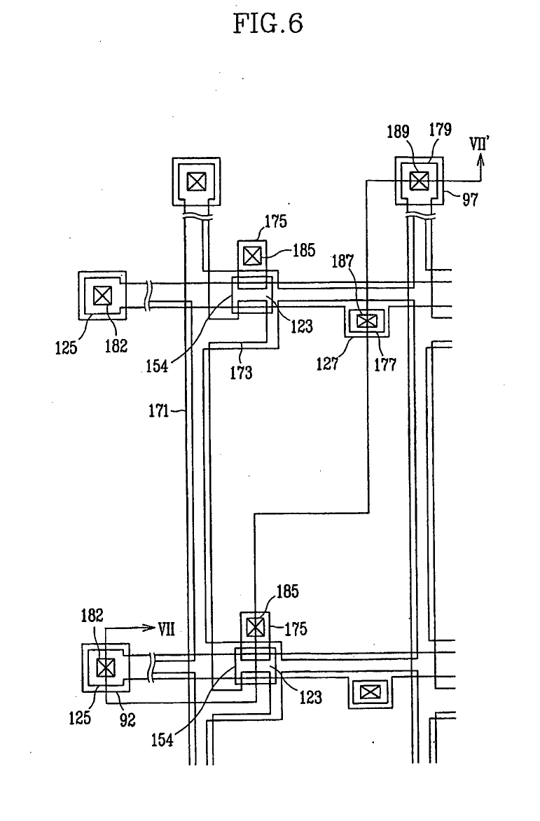

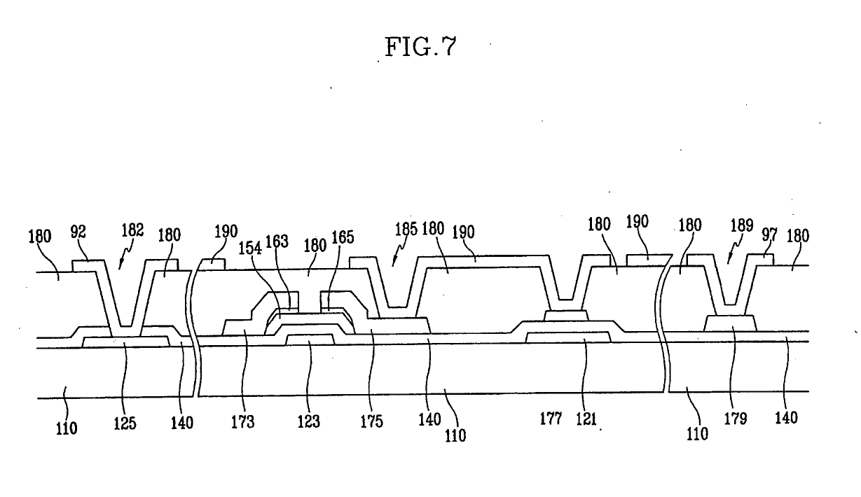

An exemplary detailed structure of a TFT array panel for an LCD according to an embodiment of the present invention will be described with reference to FIGS. 6 and 7.

FIG. 6 is a layout view of an exemplary TFT array panel for an LCD according to an embodiment of the present invention, and FIG. 7 is a sectional view of the TFT array panel shown in FIG. 6 taken along the line VII-VII′.

A plurality of gate lines 121 for transmitting gate signals are formed on an insulating substrate 110. Each gate line 121 extends substantially in a transverse direction and a plurality of portions of each gate line 121 form a plurality of gate electrodes 123. Each gate line 121 includes a plurality of expansions 127 protruding downward.

The gate lines 121 include a low resistivity conductive layer preferably made of Ag containing metal such as Ag and Ag alloy or Al containing metal such as Al and Al alloy. The gate lines 121 may have a multilayered structure including a low resistivity conductive layer and another layer preferably made of Cr, Ti, Ta, Mo or their alloys such as MoW alloy having good physical, chemical and electrical contact characteristics with other materials such as ITO (indium tin oxide) and IZO (indium zinc oxide). A good exemplary combination of such layers is Cr and Al—Nd alloy.

The lateral sides of the gate lines 121 are tapered, and the inclination angle of the lateral sides with respect to a surface of the substrate 110 ranges about 30-80 degrees.

A gate insulating layer 140 preferably made of silicon nitride (SiNx) is formed on the gate lines 121.

A plurality of semiconductor islands 154 preferably made of hydrogenated amorphous silicon (abbreviated to “a-Si”) are formed on the gate insulating layer 140.

A plurality of ohmic contact islands 163 and 165 preferably made of silicide or n+ hydrogenated a-Si heavily doped with n type impurity are formed on the semiconductor islands 154. The ohmic contact islands 163 and 165 are located in pairs on the semiconductor islands 154.

The lateral sides of the semiconductor islands 154 and the ohmic contacts 163 and 165 are tapered, and the inclination angles thereof are preferably in a range between about 30-0 degrees.

A plurality of data lines 171, a plurality of drain electrodes 175, and a plurality of storage capacitor conductors 177 are formed on the ohmic contacts 163 and 165 and the gate insulating layer 140.

The data lines 171 for transmitting data voltages extend substantially in the longitudinal direction and intersect the gate lines 121. A plurality of branches of each data line 171, which extend toward the drain electrodes 175, form a plurality of source electrodes 173. Each pair of the source electrodes 173 and the drain electrodes 175 are separated from each other and opposite each other with respect to a gate electrode 123. A gate electrode 123, a source electrode 173, and a drain electrode 175 along with a semiconductor island 154 form a TFT having a channel formed in the semiconductor island 154 disposed between the source electrode 173 and the drain electrode 175.

The storage capacitor conductors 177 overlap the expansions 127 of the gate lines 121.

The data lines 171, the drain electrodes 175, and the storage capacitor conductors 177 also include a low resistivity conductive layer preferably made of Ag containing metal such as Ag and Ag alloy or Al containing metal such as Al and Al alloy. The data lines 171, the drain electrodes 175, and the storage capacitor conductors 177 may have a multilayered structure including a low resistivity conductive layer and another layer preferably made of Cr, Ti, Ta, Mo or their alloys such as MoW alloy having good physical, chemical and electrical contact characteristics with other materials such as ITO (indium tin oxide) and IZO (indium zinc oxide). A good exemplary combination of such layers is Cr and Al—Nd alloy.

The lateral sides of the data lines 171, the drain electrodes 175, and the storage capacitor conductors 177 are tapered, and the inclination angle of the lateral sides with respect to a surface of the substrate 110 ranges about 30-80 degrees.

The ohmic contacts 163 and 165 interposed only between the underlying semiconductor islands 154 and the overlying data lines 171 and the overlying drain electrodes 175 thereon and reduce the contact resistance therebetween.

A passivation layer 180 is formed on the data lines 171, the drain-electrodes 175, the storage conductors 177, and the exposed portions of the semiconductor islands 154. The passivation layer 180 is preferably made of photosensitive organic material having a good flatness characteristic, low dielectric insulating material such as a-Si:C:O and a-Si:O:F formed by plasma enhanced chemical vapor deposition (PECVD), or inorganic material such as silicon nitride. Alternatively, the passivation layer 180 may includes both a SiNX film and an organic film.

The passivation layer 180 has a plurality of contact holes 185, 187 and 189 exposing the drain electrodes 175, the storage conductors 177, and end portions 179 of the data lines 171, respectively. The passivation layer 180 and the gate insulating layer 140 has a plurality of contact holes 182 exposing end portions 125 of the gate lines 121.

A plurality of pixel electrodes 190 and a plurality of contact assistants 92 and 97, which are preferably made of IZO or ITO, are formed on the passivation layer 180.

The pixel electrodes 190 are physically and electrically connected to the drain electrodes 175 through the contact holes 185 and to the storage capacitor conductors 177 through the contact holes 187 such that the pixel electrodes 190 receives the data voltages from the drain electrodes 175 and transits the received data voltages to the storage capacitor conductors 177.

Referring back to FIG. 2, the pixel electrodes 190 supplied with the data voltages generate electric fields in cooperation with the common electrode 270 on the other panel 200, which reorient liquid crystal molecules in the liquid crystal layer 3 disposed therebetween.

As described above, a pixel electrode 190 and a common electrode 270 form a liquid crystal capacitor C_{LC}, which stores applied voltages after turn-off of the TFT Q. An additional capacitor called a “storage capacitor,” which is connected in parallel to the liquid crystal capacitor C_{LC}, is provided for enhancing the voltage storing capacity. The storage capacitors are implemented by overlapping the pixel electrodes 190 with the gate lines 121 adjacent thereto (called “previous gate lines”). The capacitances of the storage capacitors, i.e., the storage capacitances are increased by providing the expansions 127 at the gate lines 121 for increasing overlapping areas and by providing the storage capacitor conductors 177, which are connected to the pixel electrodes 190 and overlap the expansions 127, under the pixel electrodes 190 for decreasing the distance between the terminals.

The pixel electrodes 190 overlap the gate lines 121 and the data lines 171 to increase aperture ratio but it is optional.

The contact assistants 92 and 97 are connected to the exposed end portions 125 of the gate lines 121 and the exposed end portions 179 of the data lines 171 through the contact holes 182 and 189, respectively. The contact assistants 92 and 97 are not requisites but preferred to protect the exposed portions 125 and 179 and to complement the adhesiveness of the exposed portion 125 and 179 and external devices.

According to another embodiment of the present invention, the pixel electrodes 190 are made of transparent conductive polymer. For a reflective or transflective LCD, the pixel electrodes 190 include opaque reflective metal.

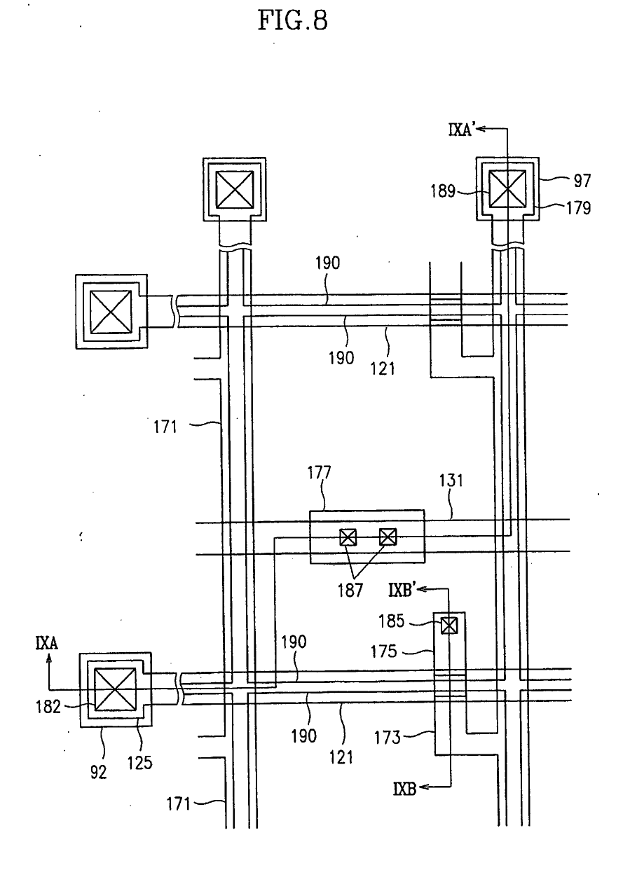

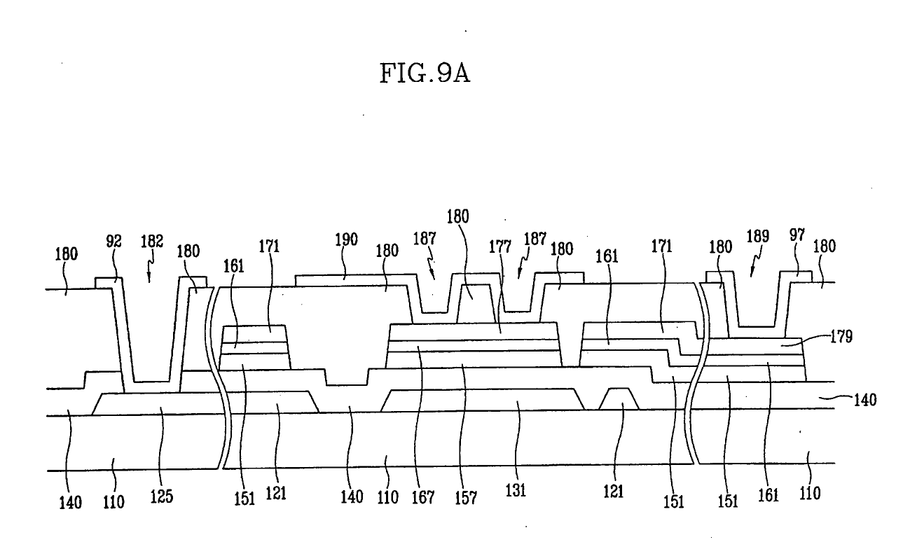

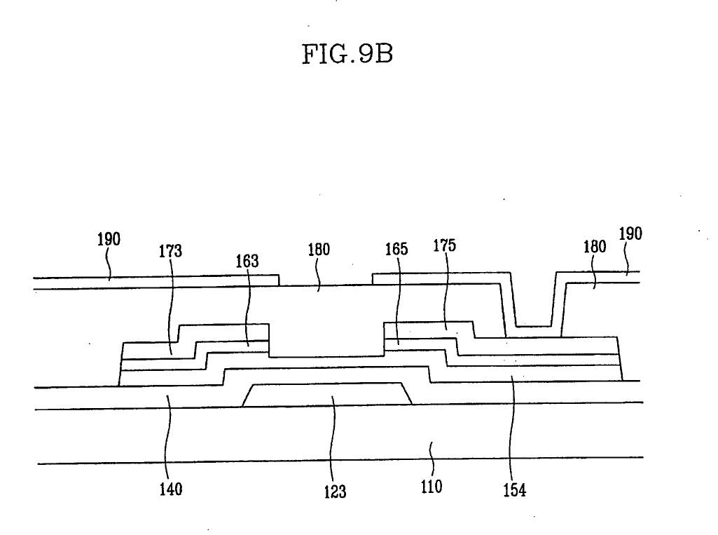

A TFT array panel for an LCD according to another embodiment of the present invention will be described in detail with reference to FIGS. 8, 9A and 9B.

FIG. 8 is a layout view of an exemplary TFT array panel for an LCD according to another embodiment of the present invention, and FIGS. 9A and 9B are sectional views of the TFT; array panel shown in FIG. 8 taken along the line IXA-IXA′ and the line IXB-IXB′, respectively.

As shown in the figures, a layered structure of a TFT array panel of an LCD according to this embodiment is almost the same as that shown in FIGS. 6 and 7. That is, a plurality of gate lines 121 including a plurality of gate electrodes 123 are formed on a substrate 110, and a gate insulating layer 140 is formed thereon. A plurality of semiconductor stripes 151 including a plurality of extensions 154 corresponding to the semiconductor islands 154 shown in FIGS. 6 and 7 are formed on the gate insulating layer 140, and a plurality of ohmic contact stripes 161 including a plurality of extensions 163 corresponding to the ohmic contact islands 163 shown in FIGS. 6 and 7 and a plurality of ohmic contact islands 165 are formed on the semiconductor stripes 151. A plurality of data lines 171 including a plurality of source electrodes 173, a plurality of drain electrodes 175, and a plurality of storage capacitor conductors 177 are formed on the ohmic contacts 161 and 165, and a passivation layer 180 is formed thereon. A plurality of contact holes 182, 185, 187 and 189 are provided at the passivation layer 180 and/or the gate insulating layer 140, and a plurality of pixel electrodes 190 and a plurality of contact assistants 92 and 97 are formed on the passivation layer 180.

Different from the TFT array panel shown in FIGS. 6 and 7, the TFT array panel according to this embodiment provides a plurality of storage electrode lines 131, which are separated from the gate lines 121, on the same layer as the gate lines 121, and overlaps the storage electrode lines 131 with the storage capacitor conductors 177 to form storage capacitors without expansions of the gate lines 121. The storage electrode lines 131 are supplied with a predetermined voltage such as the common voltage. The storage electrode lines 131 along with the storage capacitor conductors 177 may be omitted if the storage capacitance generated by the overlapping of the gate lines 121 and tire pixel electrodes 190 is sufficient.

In addition, as well as the semiconductor stripes 151 and the ohmic contacts 161 and 165, a plurality of semiconductor islands 157 and a plurality of ohmic contacts 167 thereover are provided between the storage conductors 177 and the gate insulating layer 140.

The semiconductor stripes and islands 151 and 157 have almost the same planar shapes as the data lines 171, the drain electrodes 175 and the storage capacitor conductors 177 as well as the underlying ohmic contacts 161, 165 and 167, except for the extensions 154 where TFTs are provided. In particular, the semiconductor islands 157, the ohmic contact islands 167 and the storage conductors 177 have substantially the same planar shape. The semiconductor stripes 151 include some exposed portions, which are not covered with the data lines 171, the drain electrodes 175 and the storage conductors 177, such as portions located between the source electrodes 173 and the drain electrodes 175.

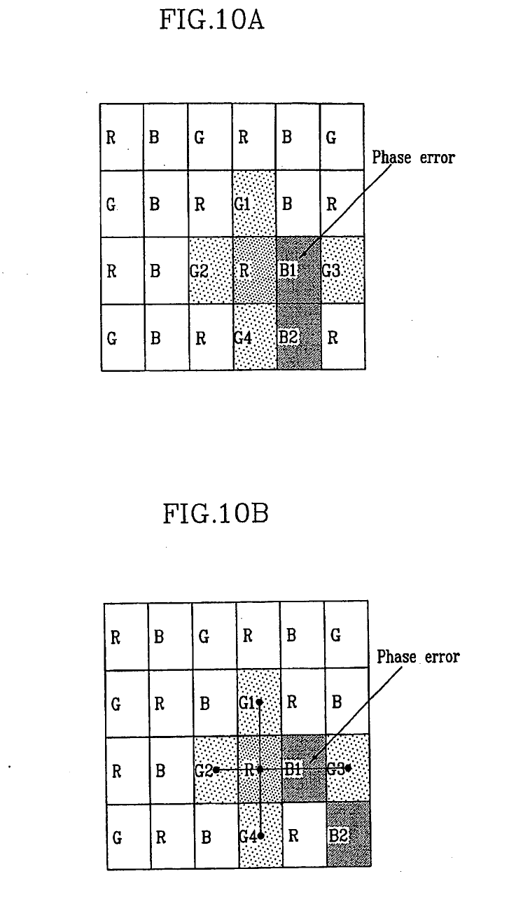

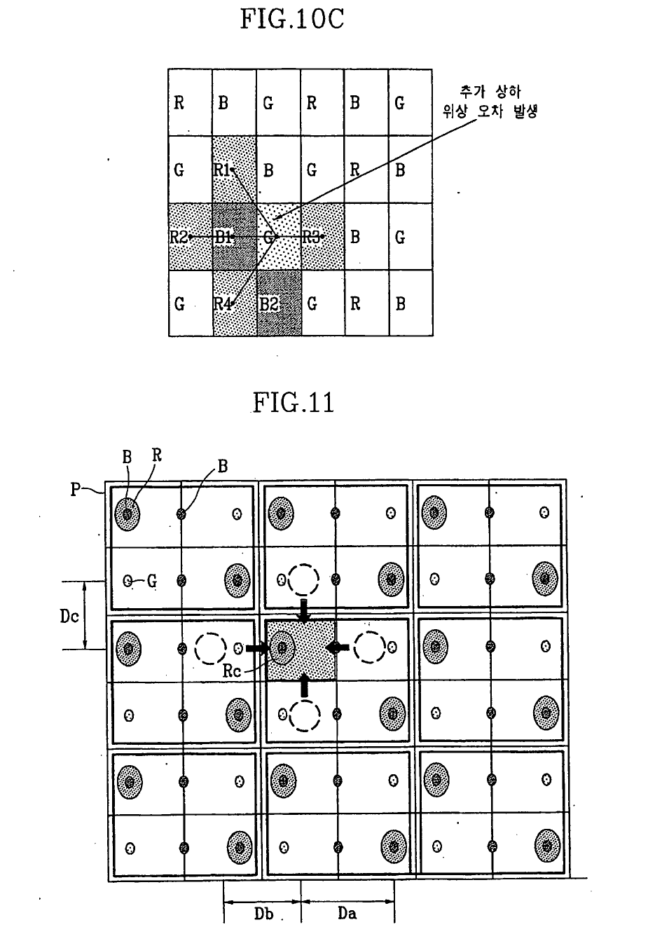

LCDs having the above-described pixel arrangements are rendered for increasing resolution and this will be described in detail with reference to FIGS. 10A-10C.

FIGS. 10A-10C are exemplary pixel groups for rendered LCDs according to embodiments of the present invention. The rendering shown in FIG. 10A is based on the pixel arrangement shown in FIG. 3A, and that shown in FIGS. 10B and 10C are based on the pixel arrangement shown in FIG. 4A.

Referring to FIG. 10A, an exemplary pixel group for rendering is centered on any pixel in a bicolor pixel column. The pixel group includes four pixels (referred to as “peripheral pixels” hereinafter) in bicolor columns and two pixels in a unicolor column, which are adjacent to the center pixel FIG. 10A shows a pixel group including a red pixel R, and four green pixels G1-G4 and two blue pixels B1 and B2, which are adjacent to the red pixel R.

Referring to FIGS. 10B and 10C, an exemplary pixel group for rendering includes a central red pixel R, and four green pixels G1-G4 (referred to as “peripheral pixels” hereinafter) and two blue pixels B1 and B2, which are adjacent to the center pixel R, or includes a central green pixel G, and four red pixels R1-R4 (referred to as “peripheral pixels” hereinafter) and two blue pixels B1 and B2, which are adjacent to the center pixel G.

According to an embodiment of the present invention, a rendering shown in FIGS. 10A-10C give a weight equal to or larger than half of the total weight to a central pixel and equal weights to peripheral pixels. However, this causes a phase error generated due to the difference in distance between the peripheral pixels and the center pixel.

In the examples shown in FIGS. 10A and 10B, the distance (referred to as a “first distance” hereinafter) between the central red pixel R and upper, left and lower green pixels G1, G2 are equal, while the distance (referred to as a “second distance” hereinafter) between the central red pixel R is larger than the first distance since there is interposed a blue pixel between the red pixel R and a right green pixel G3, which generate a phase error.

In the example shown in FIG. 10C, a phase error due to the difference between the first distance between the green pixel G and the right green pixel R3 and the second distance between the green pixel G and the left pixel R2 is generated. In addition, although the distances (referred to as a “third distance” hereinafter) between the green pixel G and two red pixels R1 and R4 offset therefrom are equal, an additional longitudinal phase error due to the difference between the third distance and the first and the second distances.

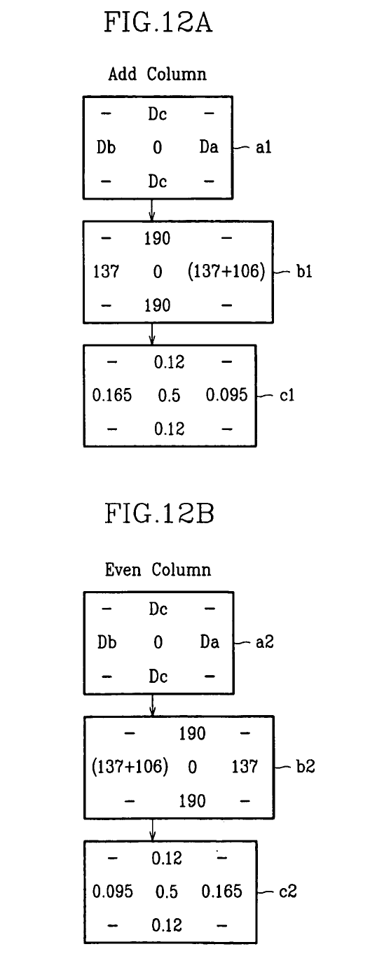

In order to remove the phase error, the weight for the peripheral pixels are different depending on the distance between the peripheral pixel and the center pixel, which will be described in detail with reference to FIGS. 11, 12A and 12B.

FIG. 11 illustrates an exemplary weighting in rendering of an LCD according to an embodiment of the present invention, FIGS. 12A and 12B exemplary weighting in rendering of an LCD shown in FIGS. 10B and 10C, respectively.

The example shown in FIG. 11 is based on the rendering shown in FIG. 10A. The distance between the green pixel G and the red pixel Rc in a dot P along a row direction is indicated by “Da,” the distance between two pixels adjacent in the row direction is indicated by “Db,” and the distance between two pixels adjacent in a column direction is indicated by “Dc.”

In this way, for the exemplary rendering shown in FIG. 10B, the distance for the red pixel R is equal to “0”, the distance between the red pixel R and the left green pixel G2 is equal to Db, the distance between the red pixel R and the right green pixel G3 is equal to Da, and the distance between the red pixel R and the upper and the lower green pixels G1 and G4 are equal to Dc, as represented by a1 in FIG. 12A.

Here, it is assumed that the pitches of the red pixels R and the green pixel G are “190 (column direction)×137 (row direction)”, the pitch of the blue pixels B is “190 (column direction)×106 (row direction)”, which is smaller in the row direction than the red and the green pixels R and G, and the size of a dot P is “380 (longitudinal length)×380 (transverse length)”.

Then, the example a1 shown in FIG. 12A is represented by b1 in FIG. 12A. It can be seen that the distance between the red pixel R and the left green pixel G2 is longer than the distance between the red pixel R and the right green pixel G3.

The weights for the pixels are determined considering the distance. For example, when rendering 32 gray with a center red pixel R, the red pixel R is assigned with a weight of about 0.5, and the peripheral green pixels G1 G4 are assigned with weights of remaining total weight of about 0.5 depending on the distance from the red pixel R, as represented c1 in FIG. 12A. The weight becomes reduced as the distance from the center pixel R is increased, thereby compensating the decreased display ratio.

As shown in c1 in FIG. 12A, the left green pixel G2 closest to the red pixel R is weighted with 0.165, the upper and the lower green pixels G1 and G4 next closet to the red pixel R is weighted with 0.12, and the right green pixel R3 is weighted with 0.095.

Referring to FIG. 12B, when rendering as shown in FIG. 10C, the weight for the peripheral pixels is determined considering the distance from the center pixel.

Referring back to FIG. 1, the gray voltage generator 800 generates two sets of a plurality of gray voltages related to the transmittance of the pixels. The gray voltages in one set have a positive polarity with respect to the common voltage Vcom, while those in the other set have a negative polarity with respect to the common voltage Vcom.

The gate driver 400 is connected to the gate lines G₁-Gₙ of the panel assembly 300 and synthesizes the gate-n voltage Von and the gate off voltage Voff to generate gate signals for application to the gate lines G₁-Gₙ.

The data driver 500 is connected to the data lines D₁-Dₘ of the panel assembly 300 and applies data voltages selected from the gray voltages supplied from the gray voltage generator 800 to the data lines D₁-Dₘ.

Now, the operation of the LCD will be described in detail

The signal controller 600 is supplied with RGB image signals R, G and B and input control signals controlling the display thereof such as a vertical synchronization signal Vsync, a horizontal synchronization signal Hsync, a main clock MCLK, and a data enable signal DE, from an external graphic controller (not shown). After generating gate control signals CONT1 and data control signals CONT2 and processing the image signals R, G and B suitable for the operation of the panel assembly 300 on the basis of the input control signals and the input image signals R, G and B, the signal controller 600 provides the gate control signals CONT1 for the gate driver 400, and the processed image signals R′, G′ and B′ and the data control signals CONT2 for the data driver 500.

The processing of the image signals R, G and B includes a data processing for rendering, which assigns weight to the pixels depending on the distance from the central pixel.

The gate control signals CONT1 include a vertical synchronization start signal STV for informing of start of a frame, a gate dock signal CPV for controlling the output time of the gate-on voltage Von, and an output enable signal OE for defining the width of the gate-on voltage Von. The data control signals CONT2 include a horizontal synchronization start signal STH for informing of start of a horizontal period, a load signal LOAD or TP for instructing to apply the appropriate data voltages to the data lines D₁-Dₘ, an inversion control signal RVS for reversing the polarity of the data voltages (with respect to the common voltage Vcom) and a data clock signal HCLK.

The data driver 500 receives a packet of the image data R′, G′ and B′ for a pixel row from the signal controller 600 and converts the image data R′, G′ and B′ into the analogue data voltages selected from the gray voltages supplied from the gray voltage generator 800 in response to the data control signals CONT2 from the signal controller 600.

Responsive to the gate control signals CONTN from the signals controller 600, the gate driver 400 applies the gate-on voltage Von to the gate line G₁-Gₙ, thereby turning on the switching elements Q connected thereto.

The data driver 500 applies the data voltages to the corresponding data lines D₁-Dₘ for a turn-on time of the switching elements Q (which is called “one horizontal period” or “1H” and equals to one periods of the horizontal synchronization signal Hsync, the data enable signal DE, and the gate clock signal CPV). Then, the data voltages in turn are supplied to the corresponding pixels via the turned-on switching elements Q.

The difference between the data voltage and the common voltage Vcom applied to a pixel is expressed as a charged voltage of the LC capacitor C_{LC}, i.e., a pixel voltage. The liquid crystal molecules have orientations depending on the magnitude of the pixel voltage and the orientations determine the polarization of light passing through the LC capacitor C_{LC}. The polarizers convert the light polarization into the light transmittance.

By repeating this procedure, all gate lines G₁-Gₙ are sequentially supplied with the gate-on voltage Von during a frame, thereby applying the data voltages to an pixels. When the next frame starts after finishing one frame, the inversion control signal RVS applied to the data driver 500 is controlled such that the polarity of the data voltages is reversed (which is called “frame inversion”). The inversion control signal RVS may be also controlled such that the polarity of the data voltages flowing in a data line in one frame are reversed (which is called “line inversion”), or the polarity of the data voltages in one packet are reversed (which is called “dot inversion”).

Although preferred embodiments of the present invention have been described in detail hereinabove, it should be dearly understood that many variations and/or modifications of the basic inventive concepts herein taught which may appear to those skilled in the present art will still fall within the spirit and scope of the present invention, as defined in the appended claims.

What is claimed is:

1. A liquid crystal display comprising:
an array of a plurality of alternately arranged first and second rows of pixels, each first row including red, blue and green pixels or red, green and blue pixel arranged in sequence and each second row including red, blue and green pixels or red, green and blue pixel arranged in sequence and having an arrangement shifted by one pixel from the first row, each pixel including a pixel electrode and a thin film transistor;
a plurality of gate lines extending in a row direction for transmitting a gate signal to the pixels; and
a plurality of data lines extending in a column direction for transmitting data signals to the pixels.

2. The liquid crystal display of claim 1, wherein the liquid crystal display is rendered.

3. The liquid crystal display of claim 2, wherein a pixel group for rendering includes a center pixel and a plurality of peripheral pixels having weights depending on a distance from the center pixel.

4. The liquid crystal display of claim 3, wherein the weight becomes large as the distance from the center pixel increases.

5. The liquid crystal display of claim 1, wherein each data line includes a connection portion for receiving data signals from an external device.

6. The liquid crystal display of claim 1, further comprising a passivation layer interposed between the pixel electrodes and the gate lines and the data lines, made of low dielectric material, and having a plurality of contact holes for connecting the thin film transistors and the pixel electrodes.

7. A method of driving a liquid crystal display including a plurality of pixels including a plurality of switching elements, a plurality of signal lines connected to the switching elements, the method comprising:
weighting the pixels for rendering based on a pixel group including a center pixel and a plurality of peripheral pixels such that weight for the pixels depends on a distance from the center pixel;
providing data voltages to the data lines, the data voltages having values depending on the weight; and
turning on the switching elements to transmit the data voltages to the pixel electrodes.

8. The liquid crystal display of claim 7, wherein the weight becomes large as the distance from the center pixel increases.
